(19) United States
(12) Patent Application Publication
(10) Pub. No.: US 2012/0056436 A1
(43) Pub. Date: Mar. 8, 2012

(54) SYSTEM AND METHOD TO INCREASE THE OVERALL SYSTEM EFFICIENCY OF INTERNAL COMBUSTION BASED ELECTRIC GENERATORS

(75) Inventors: Thomas J. Russell, Canandaigua, NY (US); Andrew Naukam, Rochester, NY (US)

(73) Assignee: Ultralife Corporation, Newark, NY (US)

(21) Appl. No.: 13/223,262

(22) Filed: Aug. 31, 2011

Related U.S. Application Data
(60) Provisional application No. 61/379,606, filed on Sep. 2, 2010.

(51) Int. Cl. F02D 29/06

(52) U.S. Cl. 290/40 B

(57) ABSTRACT

Disclosed are systems and methods to generate backup and remote electrical power, including operating an internal combustion engine to rotate a standard electrical generator. This approach can be based on a variety of engine types such as but not limited to diesel, gasoline, turbine and many other engine types. Each of these technologies have respective efficiency curves based on engine speed, load and many other factors. Often the maximum efficiency point is not the current load demand of the generator system. The disclosed systems and methods are directed to enabling the various generator sets to operate at or near their peak efficiency while they are running, thereby improving the overall efficiency of the generator systems.

This application claims priority from U.S. Provisional Application 61/379,606 for a “SYSTEM AND METHOD TO INCREASE THE OVERALL SYSTEM EFFICIENCY OF INTERNAL COMBUSTION BASED ELECTRIC GENERATORS,” by T. Russell, filed Sep. 2, 2010, which is hereby incorporated by reference in its entirety.

The disclosed systems and methods are directed to remote power systems and more particularly to systems that enable the optimization of use of generators and the like that are employed in non-grid power systems. The disclosed systems and methods control the operation of non-grid power systems to optimize the efficiency of system components including generator sets (Gensets), batteries, etc. Accordingly, the disclosed system optimizes generator operation through the use of energy storage and electronic controls.

### BACKGROUND AND SUMMARY

Although aspects of the following disclosure are directed to military applications, it will be appreciated that the disclosed systems and methods find further use in various remote and non-grid power applications (military, oil, remote cell and communication sites, off grid, emergency/disaster power, developing nations, and other generator-based industries), where the systems are not connected to or intertied with a utility grid. It is well-known that remote power systems often use generators powered by diesel engines and similar devices. Such systems may be provided by companies such as SAIC, NEC Corp., Lockheed-Martin Corp. and Mechron Power Systems.

Moreover, fuel consumption and cost, along with personnel safety, are issues of concern for the military in remote in-theater locations. Through generator optimization, the disclosed systems and methods can reduce fuel consumption by 25%-30%. Moreover, the proposed system eliminates the need for full size back-up gensets and works in conjunction with main or primary generators. The disclosed system provides the energy storage necessary to allow a main genset to run at optimal efficiency and then be turned off for periods of time. During this time, the batteries in the system (referred to as the Genset Eliminator™) will provide power to base operations and allow for silent operation.

By optimizing the use profile of existing generators with the Genset Eliminator the users can reduce fuel consumption during operations; decrease exposure of personnel to enemy attacks and lower causalities while delivering fuel, as well as reduce generator maintenance. Estimates have shown that generators running at optimal load require 50% less maintenance than those operating at 20% efficiency.

Tactical operation features and benefits of the Genset Eliminator include: lower thermal and acoustic footprint; four operational modes, including a silent mode, with electrical power fully operational; off-the-shelf electronics and batteries for serviceability; and ease of use for operational personnel. Furthermore, the Genset Eliminator can be paired or combined with other power sources including renewable energy sources such as wind turbines and solar panels. By adding energy storage to renewable sources, energy can be stored and then used when needed.

At remote in-theater military bases, electrical power is supplied from gensets that are operating 24 hours/day. At the present time, most generators are sized and operated to handle the peak load that may occur only at certain times throughout the day. The actual time during which this peak is needed is very limited; and gensets typically run at loads far below their rated capacities. Running generators with a low load forces the engine to operate at a level which compromises its efficiency and reduces its service-life. With the high number of attacks aimed at personnel delivering fuel and the dramatic rise in the price of oil, the case for using the Genset Eliminator is driven by a potential for reductions in casualties and fuel usage.

Accordingly, disclosed in embodiments herein are methods and systems for the reliable and efficient delivery of remote power, including: a power source (e.g., Genset); an energy storage system (e.g., battery bank); and a control system that monitors power consumption and history, as well as the characteristics of the energy storage system, and controls the use of the power source and/or energy storage system so as to maximize the efficiency of the power source when it is operational.

### BRIEF DESCRIPTION OF THE DRAWINGS

FIG. 1 is a general block diagram of the layout of a system in accordance with the disclosed embodiments;

FIG. 2 is a chart illustrating the efficiency of a generator relative to its rated load capacity;

FIG. 3 is a general flow diagram illustrating operations carried out by the disclosed embodiments in various scenarios;

FIG. 4 is an illustration of a conventional genset deployed with a system as disclosed herein;

FIG. 5A is one illustrative embodiment of a trailer-mounted system as disclosed herein;

FIG. 5B is an assembly view of a skid-mounted, trailerable embodiment for the system disclosed herein;

FIGS. 5C-5F illustrate additional alternative embodiments for system disclosed herein;

FIG. 5G illustrates a housing for a system as disclosed herein;

FIGS. 6 and 7 are charts providing operational information relative to an exemplary embodiment;

FIG. 8 is a detailed block diagram depicting a system in accordance with the disclosed embodiments;

FIGS. 9A-B are a detailed top and side views of an alternative embodiment of the system;

FIG. 10 is an exemplary wiring diagram for connecting a system in accordance with the disclosed embodiments; and

FIG. 11 is an exemplary wiring diagram for a system in accordance with the disclosed embodiments.

The various embodiments described herein are not intended to limit the disclosure to those embodiments described. On the contrary, the intent is to cover all alternatives, modifications and equivalents as may be included within the spirit and scope of the disclosure.

### DETAILED DESCRIPTION

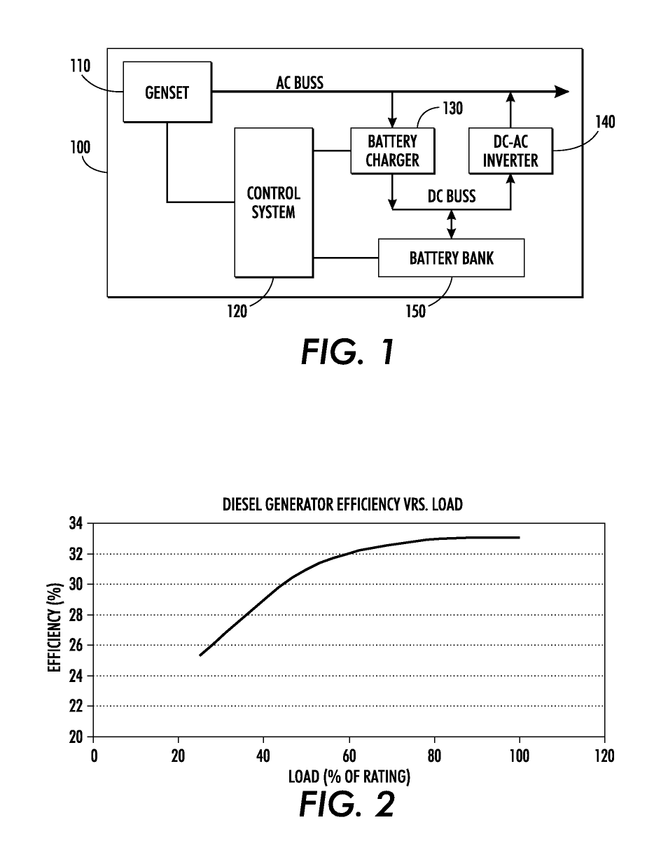

As more particularly set forth below and depicted in the following FIGS. 1-9, the disclosed system 100 and methods will allow a Generator and Engine combination (Genset 110) to operate at or near its peak efficiency point under normal conditions. When the Genset is not operated at the peak efficiency, the system will shut down the Genset and operate from batteries. Typically, but not always, the Genset achieves the maximum efficiency at or near the system's capacity. FIG. 1 presents the basic system diagram.

Referring to FIG. 1, in the block diagram for the system 100, the genset 110 is a generic electrical generator rotated by a prime mover such as a diesel engine or similar means. The genset is operated at or near the maximum efficiency that can be achieved by assuring that the load attached to the genset, both as active electrical load and/or battery charging load, is at or near the capacity of the generator. The control system 120, for example a digital microprocessor based system, supervises and controls the operation of the power system to maintain the maximum realizable efficiency, health of the battery bank and the overall safe and convenient operation of the system. Advanced programming techniques allow a user to optimize the system both for efficiency, convenience and/or life of the batteries and Genset. It should be noted that energy use patterns of the user can be learned/stored by the control system (e.g., in a memory accessible by the control system microprocessor) and managed for the operation. Battery charger 130 charges the battery bank when directed to by the control system. DC-to-AC inverter 140 converts the stored direct-current (DC) energy of the battery bank 150 to alternating-current (AC) power as required. The Genset Eliminator can also deliver the raw DC power from the battery banks for DC loads without going through the inverters.

When the Genset is not operating, a chemical battery bank 150 will supply the necessary energy to operate a DC-AC power inverter and thus maintain AC power. The battery bank (e.g., Lead Acid, Li-Ion or other chemistry) will be charged during the time that the Genset is operating. If the battery charge level becomes depleted, the Genset will be brought on to supply the energy to charge the batteries and operate the load.

Efficiency Improvement (Diesel Generation Embodiment)

The following disclosure is largely specific to a Diesel Engine as a source of power for the Genset as will be explained. Similar approaches used with other engines or prime movers will result in an efficiency improvement that may be greater or less than the example.

There are several factors that will impact the efficiency improvement of the system. These factors include; engine efficiency at the operation point of the engine, efficiency of the battery charger, efficiency of the DC to AC inverter and round trip efficiency of the energy storage medium. Other factors enter into the efficiency of the system but with a much lesser impact.

The first factor that can be controlled is how closely the system can operate at or near the Genset's optimal efficiency. In those cases where the Genset is forced to operate without it's output being at or near the maximum efficiency point of the engine, due to the load and the amount of energy demanded by the chargers being the wrong value (e.g., mismatched), the overall system efficiency will suffer. In the case of a Diesel Genset as the main source of electrical energy, the efficiency is best if the Genset is operated at or near the system's rated capacity. FIG. 2 presents an average of several commercially available Diesel Gensets. The efficiency of the Genset is compared to the percentage of the load on the generator.

As shown in FIG. 2, if the Genset is operating below 100% of the rated capacity the efficiency of the system suffers. Other factors impact the operational patterns of the Genset as well. The value where the set point of the Genset operates regardless of the state of charge on the battery bank is variable with both the prime mover and the battery chemistry dominating the decision. In the case of Lead-Acid Batteries with a Diesel Genset the optimum state of charge to begin recharge appears to be on the order of 60% with the exact values having other dependencies that would vary that solution from application to application. The particular set-points (e.g., state of charge to begin recharge) for a bank of batteries will depend not only on the battery type or chemistry, but other factors such as battery age, temperature, etc.

Ideally the battery charger would put sufficient demand on the Genset to operate at or near optimal. To accomplish this, the battery bank must be sized to allow charging rates sufficient that will bring the load on the generator to the point where they can operate efficiently and not recharge the cells in the battery at an excessive rate. This can typically be accomplished by sizing a lead acid battery bank to allow charging requiring in excess of 4-8 hours to fully charge a fully depleted bank. Another possible embodiment is where the generator is sized at a level slightly less than a peak power requirement for the load, and then a combination of generator and battery power is supplied to the AC Buss, where the current exceeds the capacity of the generator or the batteries individually and is achieved by a combination of both. In this manner a smaller generator may be employed, particularly one that is more efficient or is more likely to operate at its highest efficiency when on.

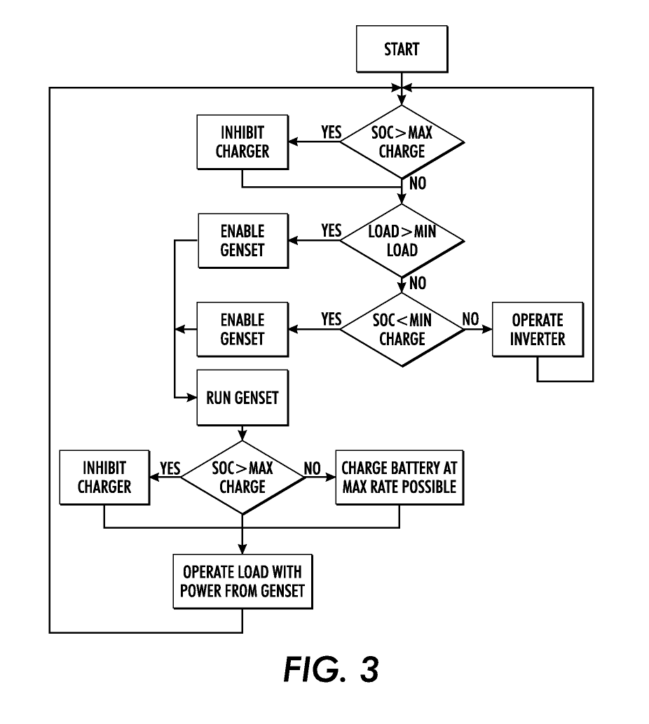

Depicted in FIG. 3 is a logical flow diagram for an embodiment of the disclosed system. As will be described in more detail below, the system operates by first determining if the state-of-charge (SOC) is greater than the maximum charge level of the battery bank. If so, charging the batteries by the battery charger (and connected generator) is inhibited. Assuming the battery bank can accept additional charge, the system next determines whether the load (current power requirement) is greater than the minimum load, or if the state-of-charge is less than the minimum charge. If either test is true (Yes), then the Genset is enabled and the “Run Genset” operation is initiated. If the state-of-charge is not less than the minimum charge, then the inverter is used to provide power to the load from the battery bank.

Turning to the “Run Genset” operation, once initiated, if the state-of-charge for the battery bank is greater than the maximum charge, the charging of the batteries is inhibited and the load is powered from the Genset. Otherwise, the batteries are charged and the Genset further provides power to the load. It will be appreciated that in this state of operation, the amount of power used to charge the battery bank can be controlled to further optimize the efficiency of the Genset, thereby powering the loads and charging the batteries at the most efficient output of the Genset. Also contemplated is the use of time-of-day limits as well as other programmable controls by which to more specifically control the operation of the system. For example, the system could include programmable time-of-day ranges to specify either times when the genset is not to be used, or is okay to be used. These time ranges could be employed so that the system initiates an earlier charge operation in order to assure that the batteries are fully charged at the beginning of a non-Genset operation period (e.g., during late-evening or early morning hours).

Having described the general operation of the systems and methods employed, a specific embodiment is now discussed. Current practice in many remote power systems is that gensets in the field are paired with a back-up genset to assure a reliable power supply. Since 10 kW gensets are a common size, this example will use that size in the following description. The advantages of a Genset Eliminator are valid for any size generator up to and above 30 kW. Above that, the number and size of the batteries needed might prevent a direct replacement of larger generators, unless multiple Genset Eliminators are linked together to create a larger storage capacity. However, this approach really has no limit as to the power levels. Using the Genset Eliminator as part of a distributed network of smaller generators or in an array themselves may also permit efficient and economical energy storage and distribution.

The main genset supplies all of the energy to run daily operations and facility equipment. The additional genset is available when the primary genset is off-line due to refueling, repairs or maintenance. An installation may have more than one genset, depending on its energy requirements.

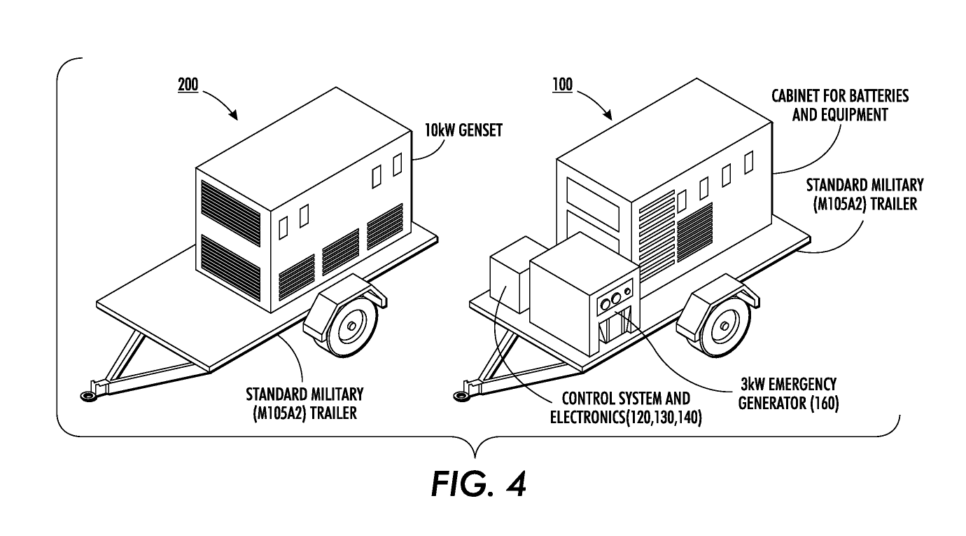

As noted above, an improved system with a better operating efficiency, lower fuel consumption and more operating modes, including a silent mode, is referred to as the Genset Eliminator. The system was designed for ease of use in operation and service by utilizing common off-the-shelf batteries and components, some of which are already in use by the U.S. military. As shown in the example of FIG. 4, the back-up genset in a conventional dual-genset configuration has been replaced with the Genset Eliminator. Referring to FIG. 4, there is shown a conventional genset 200 and a Genset Eliminator system 100. The Genset Eliminator includes batteries, a small emergency generator 160 and associated equipment, which may be mounted on an appropriate trailer (e.g., military trailer M105A2), skid/pallet or other means of transport.

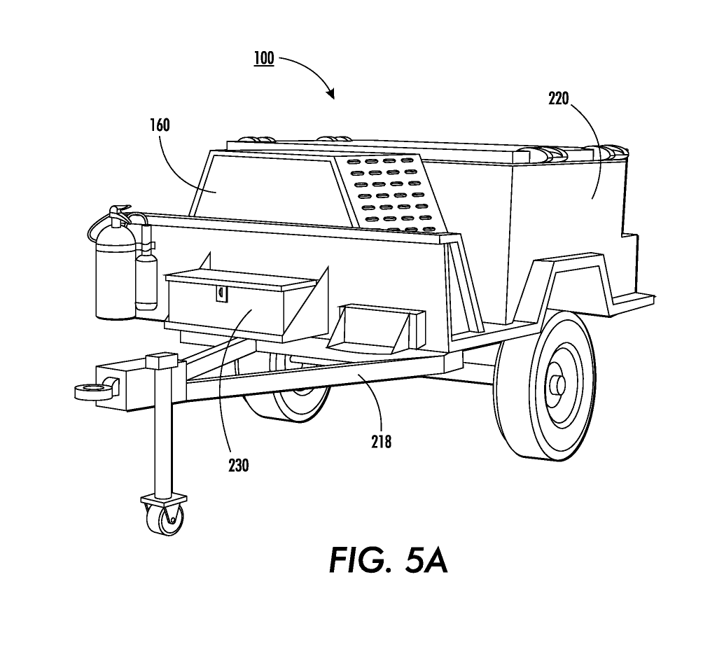

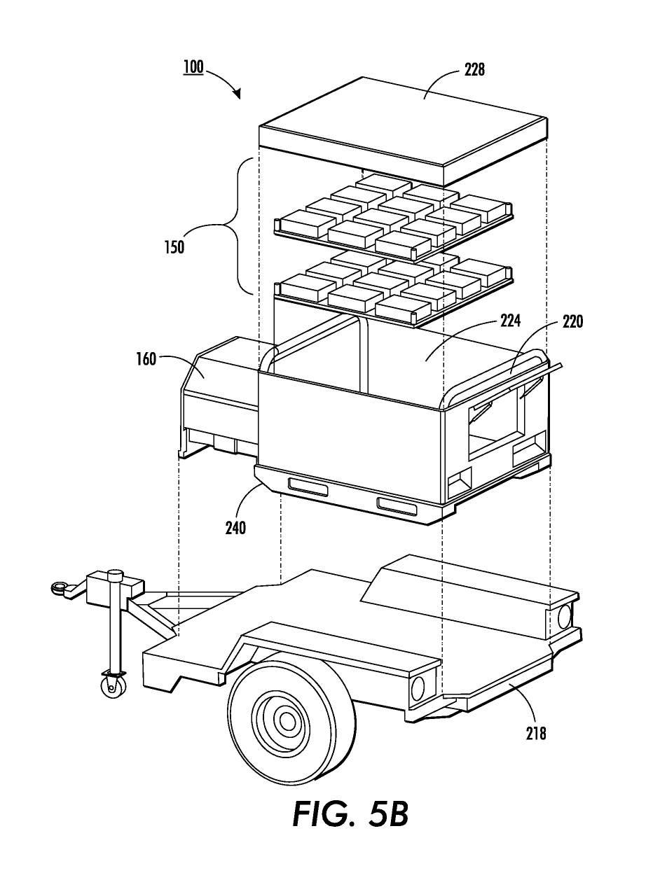

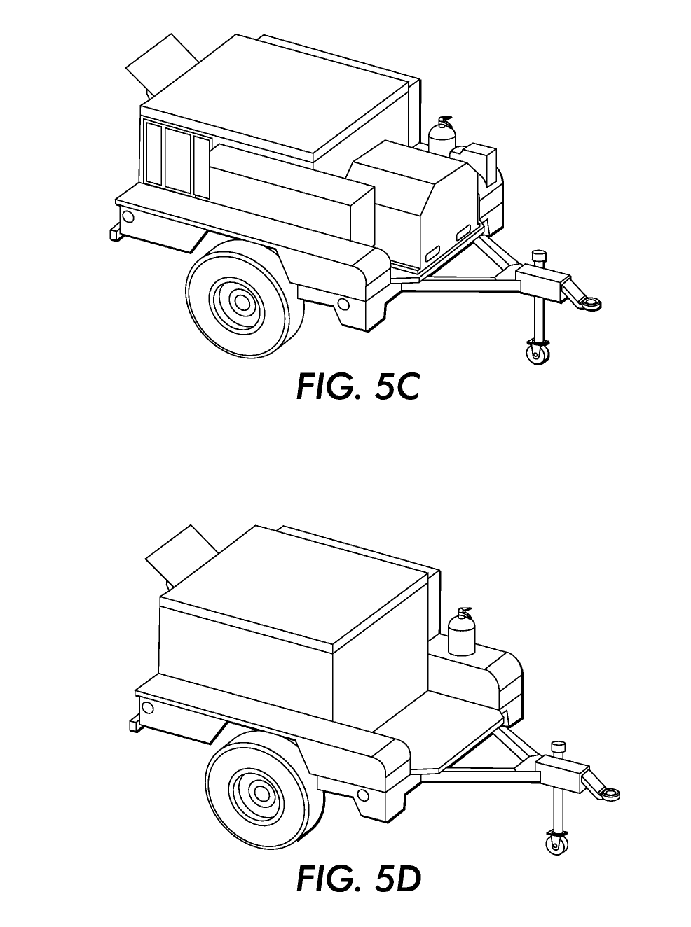

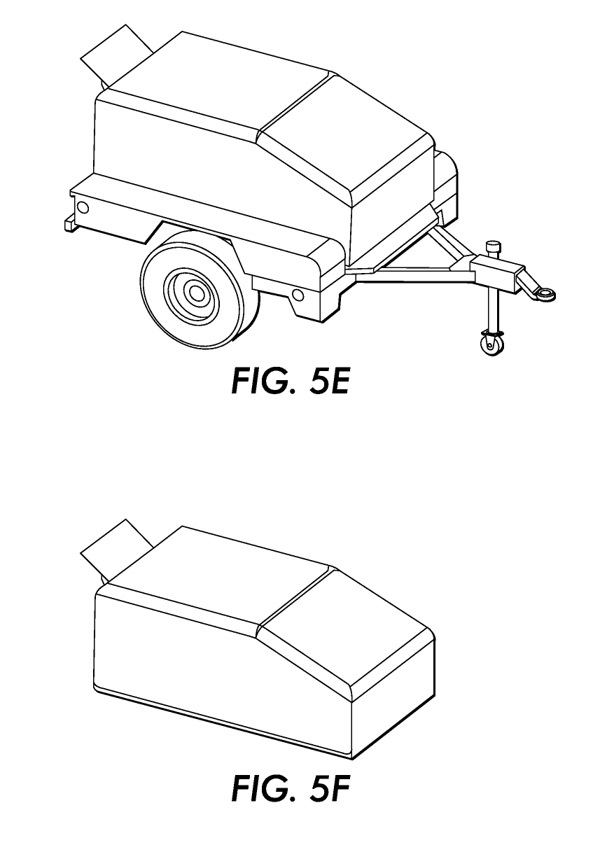

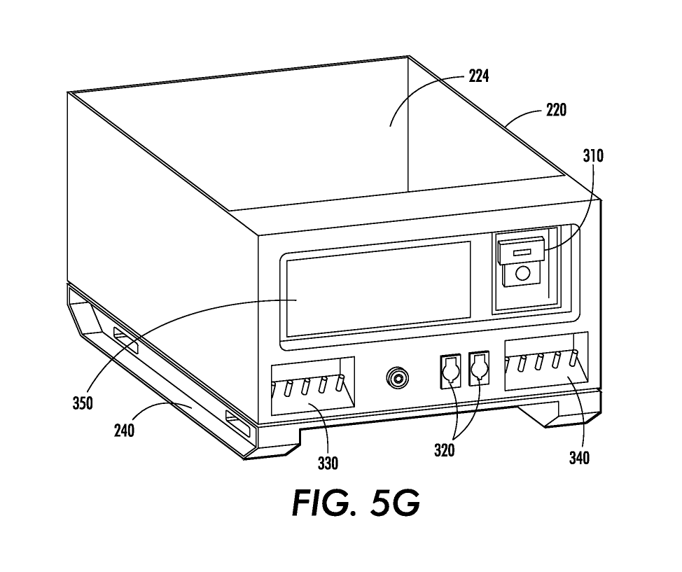

FIG. 5A is one illustrative embodiment of a trailer-mounted Genset Eliminator system 100. In the illustrated embodiment, the system 100 is integrated with a trailer 218. System 100 includes a cabinet 220 for storage of batteries and associated controls and electronics (e.g., 120, 130, 140, not shown), and a 3 kW generator 160. Also included is a shelf and lockable box 230 for storage of related tools, interconnection cables, etc.

FIG. 5B is an assembly view of a skid-mounted system 100 that is suitable for installation on or transport by trailer 218. The trailerable embodiment of FIG. 5B also illustrates a housing or cabinet 220 that includes a compartment 224 for storing a plurality of batteries in battery bank 150 inside of the compartment in racks or similar structures to retain the batteries while being transported. The cabinet includes a cover 228 for the Genset Eliminator as well. As will be appreciated from the illustration in FIG. 5B, the housing of system 100 is attached to a skid type frame 240, such that the system is structurally supported by the frame and is capable of being deployed by trailer 218 and the skid removed therefrom or remaining on the trailer.

Also considering FIGS. 5C-5F, illustrated therein are the following alternative configurations: illustrate additional alternative embodiments for the system:

FIG. 5C illustrates a 25 kW skid-based system including a backup generator 160;

FIG. 5D illustrates a 25 kW skid-based system with no backup generator;

FIG. 5E illustrates a 20-60 kW skid-based system with no backup generator; and

FIG. 5F illustrates a 20-60 kW skid-based system with no backup generator and no trailer.

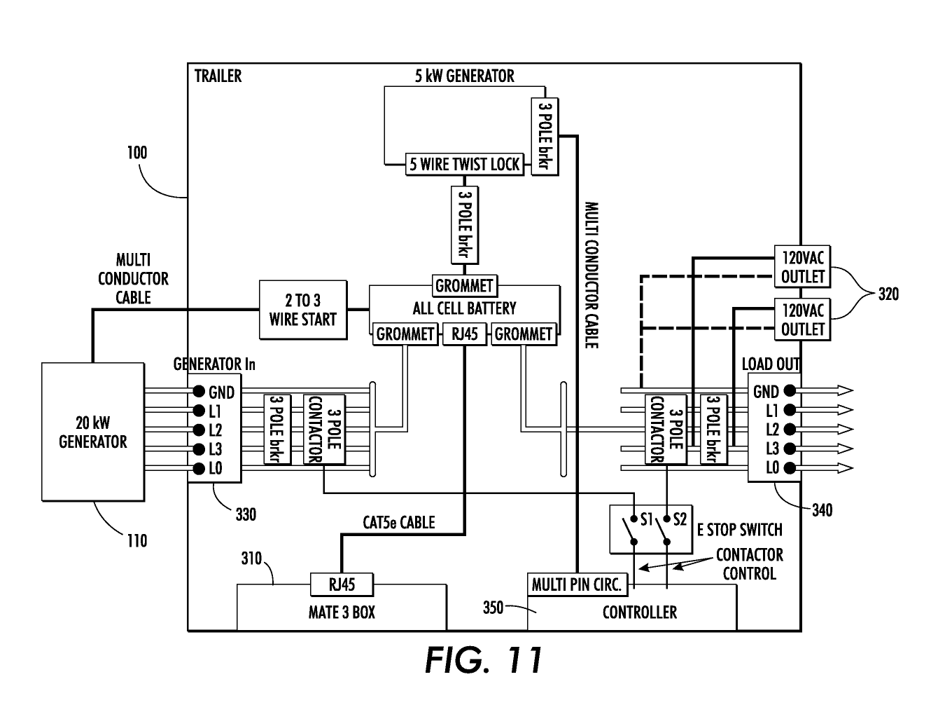

Turning next to FIG. 5G illustrated therein is a housing 220 for the Genset Eliminator. The housing, as described above includes a compartment 224 for storage of the batteries, as well as a cover (not shown). The rear face of the housing includes not only an access opening in order to inspect the batteries, but also includes various connections and controls. Included on the rear face are various bus contacts 330, 340, 120 VAC plugs 320 and a control interface 310, 350 as more specifically described and illustrated in FIG. 11.

The Genset Eliminator uses an approach that will significantly reduce the fuel consumption by exchanging the second genset for a system that will enable main or primary gensets to be operated at 85-95% of the rated load capacity for any time they are in use. By charging the batteries while at the same time supplying the base operations with power, the generators operate at higher efficiency. Once the batteries are charged, the system switches between battery power (when the energy requirements are lower) and the generator (when the load is high enough to allow for efficient operation) as was generally depicted in the flow diagram of FIG. 3. While running on batteries, the primary genset is off, allowing for silent operation. This switch between power sources will be seamless to the user. The result is lower fuel consumption and less noise. The Genset Eliminator also allows for maintenance of the main generator without a loss of power during such maintenance.

While the Genset Eliminator could be heavier than the typical 10 kW genset (approx. 300-1000 lbs.) it is still within the allowable weight of a light tactical trailer. Efficiency improvements achieved by the gensets will result in immediate and substantial savings in money and tactical effectiveness but more importantly, in lives.

The Genset Eliminator can be configured with lead acid batteries, or alternative battery chemistries such as Li-Ion, cobalt oxide and iron phosphate. More specifically, Lithium Ion batteries are advantageous due to their higher operating temperature range and lighter weight. Lithium Ion batteries provide a tremendous weight advantage when compared to lead acid batteries (8-10 times lighter than lead acid batteries needed for equivalent power storage) making Li-Ion much more portable. In addition Lithium Ion batteries can operate in temperatures up to 140° F. (60° C.) which far exceeds the temperature range of lead acid chemistry batteries, while not requiring air conditioning or cooling. Li-Ion batteries will charge more efficiently than lead acid batteries, thereby increasing the overall efficiency of the system. Future versions of the Genset Eliminator will incorporate renewable energy sources, in combination with gensets, such as wind and solar.

The following descriptions list the functional and operating differences between of current genset configurations and the Genset Eliminator working in conjunction with a main generator:

Main Genset (Currently)—without Genset Eliminator
Runs continuously to supply power for base at energy demand rate.
Running at typically low (20%) output is not optimized for generator efficiency
Large thermal and acoustic footprint

With Backup Genset
Sits idle for most of the time.
Used only as a back up to main genset when it needs fueling or servicing.

Main Genset: With Genset Eliminator
Utilized during times of heavy demand
Genset is always run at optimal efficiency load level of 85-95%
Excess energy generated is used to charge batteries
When batteries are charged, the genset is switched off and batteries supply energy to base.

With Genset Eliminator:
Optimizes main generator so it runs at highest efficiency.
Batteries provide power at other times
Can be operated in Silent Mode
Small Emergency Back-up genset may be included

The Genset Eliminator, for example, consists of an array of batteries, charger and all necessary equipment to enable the system to run efficiently and safely and can even tie to the local power grid if available, in a transportable configuration. It is backed up by an emergency generator. More specifically, the equipment in a single Genset Eliminator includes the following:

Inverter(s)

Power supply/battery charger

Armasafe+ Hawker Batteries, for example

Cabinet

Genset (3 kW size for example)

Trailer

Control System

Miscellaneous Electrical Hardware, cables, connectors

The Genset Eliminator offers numerous benefits, including: lower cost; reduction in fuel consumption of 25-30% over the standard diesel; genset operated independently; reduced engine maintenance due to more optimal loading; Improved response to short term surge requirements; reduced operating hours on gensets in use; off-the-shelf electronics and batteries; tactical operations benefits; four operational modes, with electrical power fully available, including silent; significantly fewer power interruptions; reduced thermal and acoustic footprint; and is scalable as required.

The business justification for the Genset Eliminator can be broken into three main components (reduced exposure of personnel to IEDs and the hazards of fuel transport are not addressed):
Fuel Savings—Annual expected fuel savings for the U.S. Military. Savings per generator are calculated first. The percent savings for U.S. Military is then extrapolated from that data.
Total Cost of Ownership—Cost benefit on a per generator basis of the Genset Eliminator™.
Pay Back Evaluation—A simplified payback analysis which evaluates how many months of operation are needed to have the fuel savings equal the initial cost.

The Genset Eliminator™ achieves fuel savings by operating existing gensets in a more efficient output range. As shown in the FIG. 2, for example, a generator operates more efficiently when operating at or near its maximum output capacity. Because gensets are sized to accommodate the largest expected load, gensets often operate with a load that is far less than the rated load capacity during significant portions of a 24 hour period. During the time when the load is less than the peak, the overall efficiency of the system (energy in the fuel to electrical energy) can be as low as 25%. When the system is operated more optimally, the efficiency can approach 33%. The Genset Eliminator achieves the most savings when the genset is operated at or near the rated capacity. And, as suggested above, the ability to periodically couple the output of the genset and batter/inverter may allow for smaller-sized gensets to be deployed in the first place.

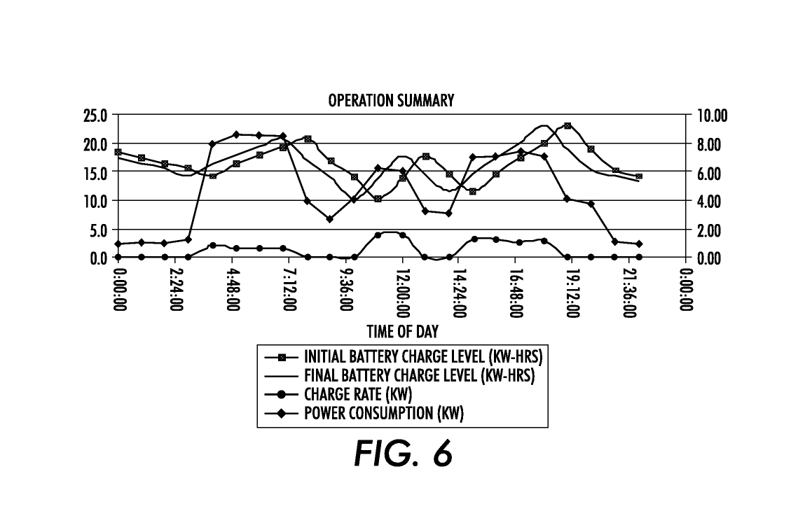

Referring also to FIG. 6 (Operation Summary), illustrated is an example of possible operational power demand shown as a function of the time of day. This assumes that during the night, the power consumption is reduced significantly from the typical daytime use. During the daytime hours, the power consumption peaks twice per day, normally associated with early morning and late afternoon activities. This obviously varies greatly from location to location but the overall impact will be similar.

Several system parameters are key in the optimization of the genset. The parameters for this example have been optimized to achieve the best fuel savings and to minimize the need for the genset to run during sleeping hours (e.g., 10 PM to 5 AM). As noted previously, other operational requirements can be incorporated when identified. Key parameters included in this example are number of batteries, battery capacity, allowable depth of discharge of batteries, charge rate, and size of generator (in kW).

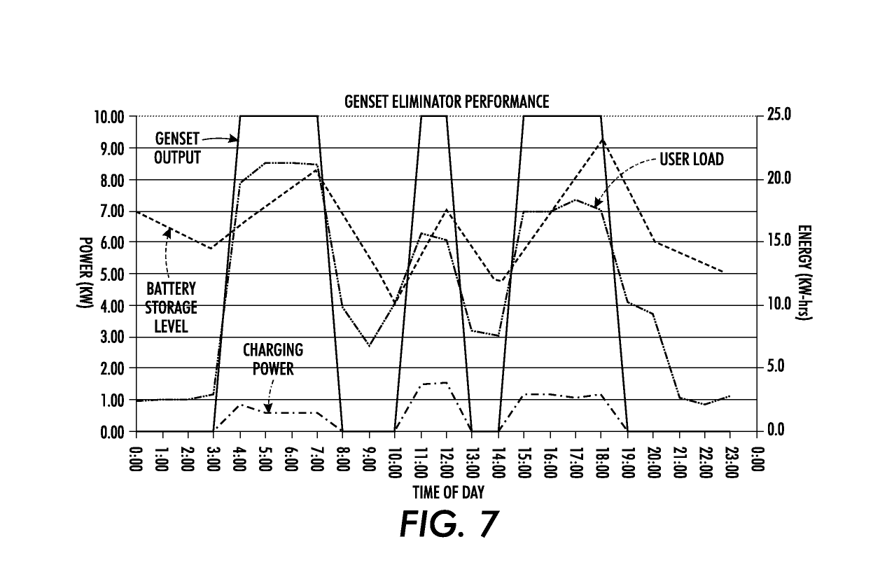

Referring also to FIG. 7, representing Genset and Genset Eliminator parameters over a 24-hour period, various operating parameters of the Genset Eliminator are presented during use. It is important to note that the genset is either on or off. This assures maximum cost avoidance. The level of discharge on the battery bank is also controlled to increase or maximize the life of the battery. Additionally the charging rate on the battery is controlled to minimize battery deterioration during fast charging.

Using this input data, a simulation of the Genset Eliminator in operation shows that the daily cost savings are potentially significant. In the example, savings per generator are shown to be:

Operating Genset without Genset Eliminator™: 8.9 gallons

Operating Genset with Genset Eliminator™: 6.6 gallons

Percent Reduction in fuel: 26%

Total Cost of Ownership

Through the use of the Genset Eliminator a return on investment time of approximately 30 months would be realized. Maintenance costs with the Genset Eliminator are estimated to be half since generators will be running at a higher percentage of rated load capacity. [UNITED STATES MILITARY ACADEMY (West Point, N.Y.) CENTER FOR ARMY ANALYSIS (Fort Belvoir, Va.) Army Tactical Hybrid Power system Analysis and Design (May 2004)] The example takes into account that the batteries on the Genset Eliminator would be replaced periodically. Additionally the standard practice of always having a standby genset on site would no longer be necessary, therefore eliminating that cost as well.

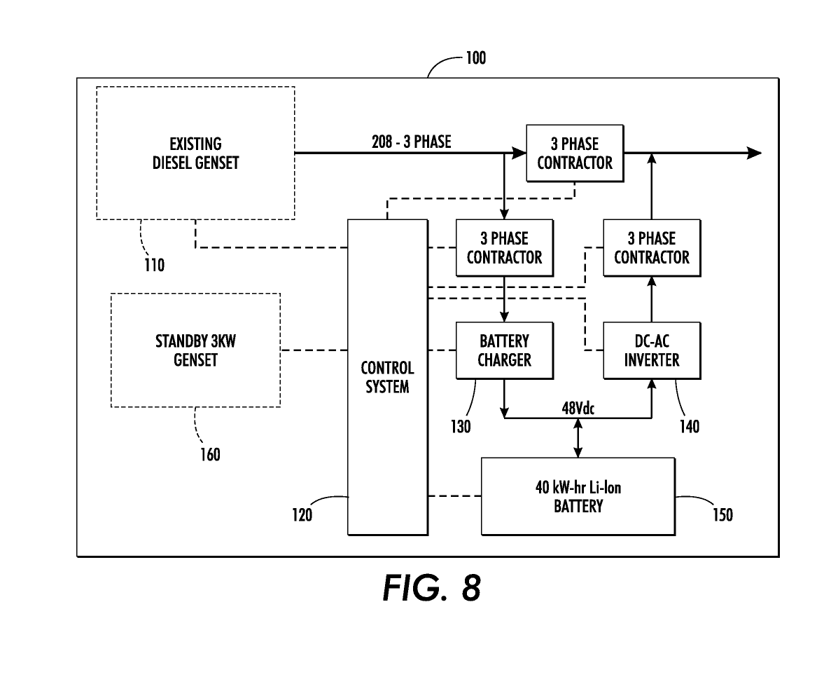

In one system configuration, the Genset Eliminator includes as many off-the-shelf components as possible for ease of repair and replacement. For example, lead acid or other types of batteries, and the associated equipment allowing the operation and grid connection, are the backbone of the system. Similar to FIG. 1, FIG. 8 is a basic block diagram showing the configuration of one embodiment of the Genset Eliminator.

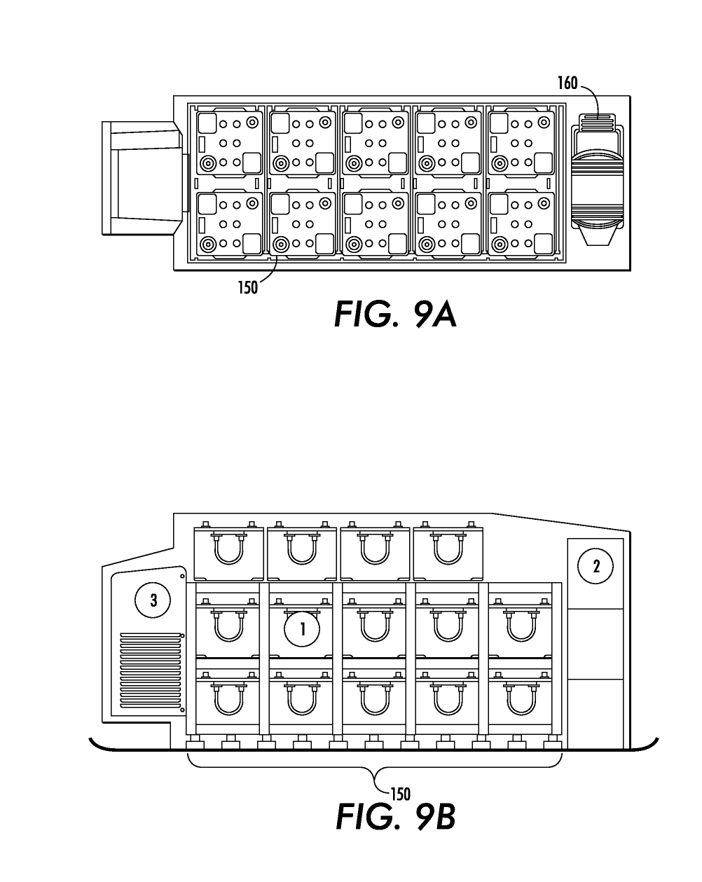

Referring also to FIGS. 8 and 9, the control system 120 will monitor power consumption, time of day and other parameters to determine the optimal time(s) to charge the battery bank. Additionally, it will allow the user to input the various operational requirements that need to be considered in the logic of the system. This will optimize the timing and duration of the genset's operation. With 28.8-40 kW-hrs of storage capacity, the battery bank could require several hours of charging at a time. This would allow sufficient time for the engine to operate efficiently. FIG. 8 also illustrates the backup or standby generator 160 in accordance with one of the Genset Eliminator embodiments.

The optimum time(s) to operate the Genset Eliminator or main genset is based on the following parameters:
Operate the system on batteries when extended operations with low consumptions are expected. This is typically at night.
Operate the genset when the load expectation is high. This will reduce the need for high power draw from the batteries and thus extend the life of the batteries.
Charge the batteries also when there is high load expectation. This will decrease the charge rate and extend the life of the batteries.
Allow the genset to be shut down for service and maintenance while operating from the battery bank.
Offer the user the advantage of silent operation reducing the acoustic and thermal signature.

It should be noted that these scenarios do not conflict. Therefore, the goals of reduced energy consumption, quiet night-time operation and extending the life of the battery bank can be achieved simultaneously.

The Genset Eliminator will have at least four operational modes:

MODE 1: True Hybrid Mode: This will be the default mode for the Genset Eliminator.

State 1a: Battery Charging State. In this state, the generator is operating. The output is used to charge the battery bank and to supply power to the user. When the battery receives a predetermined optimum charge level, the generator is shutdown and the system changes to State 1b. The battery is charged at the highest rate possible that is safe for the battery and delivers the power demanded by the user. The optimum goal is to operate the generator at 85-95% of the rated capacity. This will maximize the efficiency of generator.

State 1b: Battery Output State. In this state the generator is not operating. Power is being delivered to the end user from the batteries. The batteries are only drained to a level that will maximize the life of the batteries. When the stored energy on the battery bank is drained to this level, the generator is started and the system will be returned to State 1a. In this state the output will be converted to AC via a high efficiency/high power quality inverter.

MODE 2: Forced Silent Mode. In this mode, the generator will be prevented from coming on. The output of the batteries can be drawn down until fully discharged. Draining the batteries completely is not optimal for battery longevity. In this mode the power delivery system will present the minimal detection footprint. This mode may also be used to maintain or repair the main genset. The batteries will take longer to fully recharge.

MODE 3: Bypass Mode. In this mode the system is forced to operate with the battery banks and the associated electronics eliminated from the system. This mode would be the same as not having the battery bank connected. This mode is invoked by a manual bypass switch on the Control/Charger/Inverter unit.

MODE 4: Recovery Mode. In this mode the batteries are charged carefully after long operation in the Forced Silent Mode (Mode 2) discharge. This will automatically occur when required.

The Genset Eliminator is designed to be a self-sufficient unit with all the components necessary for operation and maintenance. Referring to FIGS. 9A-B, a Genset Eliminator conceptual layout is shown. The system's housing will be separated into compartments, as will now be described in more detail relative to the illustrated embodiment:

A compartment stores the main battery bank. To ensure maximum efficiency and protection, the cabinet will be insulated and water resistant. Ventilation will be designed into the system to minimize heat build-up. The battery bank will be mounted on a shock and vibration structure to ensure that the batteries will not be compromised when transported over rough terrain.

Compartments 2 and 3 contain a shock isolated rack system(s) for the electronics in the system. In this rack will be input rectifiers/battery charger, DC to AC power inverter and the overall control system.

The batteries may require replacement. To simplify the field replacement of a battery or a group of batteries, the compartment will have access to the battery banks from both sides of the Genset Eliminator™. All necessary tools and special equipment for replacement will be provided with a maintenance kit.

The system's dimensions (approximate) are expected to be 42 inches high with a foot print of 60 inches by 48 inches and will be limited to a weight of less than 3000 pounds. These dimensions have been chosen to allow transport via a standard military trailer). During the design of the system, the maximum number of batteries will be implemented while not exceeding this weight.

Specific effort will be devoted to simple convenient operation to make the Genset Eliminator as similar to existing equipment operation to facilitate training and field acceptance.

As described and contemplated herein the Genset Eliminator™ can be bypassed for full generator use (pass through). A Genset Eliminator, working in conjunction with the main generator, will have the following specifications:

| | |
|---|---|
| Output Power on batteries | 10 kW |
| Output power on Main Genset | 10 kW |
| System Storage Capacity | 10-60 kW-hrs |
| Output Voltage | 208/120 VAC/3 phase |
| Time on Battery (At 5 KW) | Up to 4.6 hours to 100% |
| | depth of discharge and 2.3 |
| | hours to 50% depth of |
| | discharge |
| Maximum Input Power | 10 kW |
| Input Voltage (Nominal) | 120/208 VAC/48/24 VDC |
| Frequency (output) | 47-63 Hz (settable to 1 hz |
| | tolerance) |
| Operating temperature | −20 to +60 C. |
| Size | Fits on LTT/M1101 |
| Weight | <3,000 lbs |
| Standby Genset - Included | 3 kW Typ. |

As will be appreciated, alternatives to the disclosed examples may include:
a. Various Battery Chemistries such as Pb-Acid, Li-Ion or any other that may yet to be discovered.
b. Incorporation of alternative energy sources such as fuel cells, solar or wind power.
c. Concept can range from small to very large power capacity. Savings is independent of size.

Possible uses include any place that a system is operated from power that is not derived from the power grid or it is impractical to derive power from the grid.

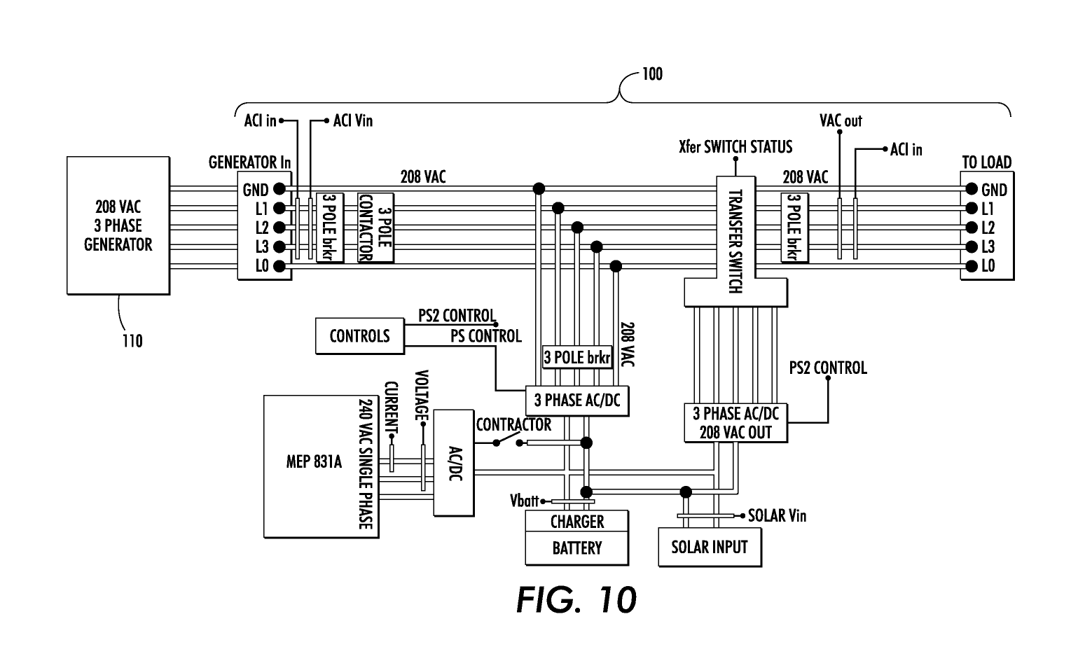

Referring next to FIG. 10, depicted therein is an exemplary wiring diagram for connecting system 100 to a genset 110 in accordance with the disclosed embodiments. This wiring arrangement contains AC to DC rectifiers, a DC to AC inverter, and a transfer switch, which physically allow for energy to be routed from either generator (or alternative input power source such as solar) to the load, and/or to the battery for charging. The system utilizes a DC Buss methodology for battery charge/discharge and solar/alternative energy inputs. Additionally an AC Buss is utilized for energy transfer in the system, both in and out of the system. The control system (CONTROLS) determines when and how much energy is directed to each element, serving to most efficiently utilize energy being generated and consumed. The control system, which includes a processor operating under programmatic control, has the capability to divert energy to the battery when charging is needed and also shut off the generator when the battery is charged and the generator output is not needed. The functions of the controller may be manually overridden, or forced, to achieve a particular function. Monitoring and display of the voltage and current through the system is available to a user.

FIG. 11 illustrates an exemplary wiring diagram for a system in accordance with a disclosed embodiment. In this embodiment the DC Buss is contained within the battery enclosure. The illustrated wiring arrangement utilizes a central battery that houses the transfer switch and bi-directional inverters/rectifiers (to achieve 3 phase capability) to which AC energy is provided and drawn. In one embodiment, certain control functionality may be provided by the OutBack Model Mate 3 controller 310, available from OutBack Power Technologies, Inc., as more particularly described in the MATE3 System Display and Controller Owner's Manual (Rev. B © July 2011 by OutBack Power Technologies), which is hereby incorporated by reference in its entirety. The control system including the MATE3 310 plus a programmable controller 350 provides overall control of the system allowing the user to choose the amount of energy being directed to and from all elements within the system. Separate cables are connected from the controller(s) to the two generators, and signals on those cables are used to control (e.g., start and stop) the two generators as needed by the system to meet load requirements. A pair of separate single phase 120 VAC Outlets 320 are shown as output choices of the system. The genset input connections are depicted at 330, whereas the system output is provided at connectors 340.

Controller 350 is a programmable master controller, including a microcontroller or microprocessor, as well as a user interface. The controller operates under programmatic control, receiving inputs from the various subcomponents of system 100, and providing output signals to control the components as well as the switching and interfacing to the load, gensets, etc. An exemplary master controller is a Texas Instruments Stellaris Arm Cortex M3 processor. In addition to providing the control of contacts and emergency stop functionality, the master controller also operates as the master or supervisory controller of the system.

The master controller provides the following functions, several of which may be pre-programmed or which may be adjusted or modified via a user interface and/or computer connection:

Programmable limits on battery charging rate and max./min. voltages allowed;

Directing power to and or from various inputs and outputs;

Determining and sending signals to start and stop the generators;

Determining the amount of energy that can be used for charging based on the external demand;

Monitoring temperature of batteries and other system components, and shut down the system according to temperature limits;

Monitoring the battery performance characteristics so as to provide an alarm(s) and/or shut down portions of the battery or the entire battery if predetermined limits are exceeded;

Controlling and monitoring the output voltage and frequency as well as other critical factors;

Providing data storage and output for monitoring capability;

Providing an interface for access for bypass, lock out, and programming;

Recording of various criteria, such as run time, temperature(s), etc.; and

Emergency stop.

As described above, the control system, including the master controller, determines when and how much energy is directed to each element, serving to efficiently utilize energy being generated and consumed. The control system has the capability to divert energy to the battery when charging is needed and to also shut off the generator when the battery system is fully charged. As in the prior embodiment, the functions of the controller may be manually overridden, or forced, to achieve a particular function. Monitoring and display of the voltage and current through the system is available to the user, either via a display associated with the Mate 3 controller or via an optional display or even a remote computer interface.

It will be appreciated that several of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A system for delivery of remote power to a load, including:
a fuel-driven power source connected to said load;
a rechargeable energy storage system, arranged to receive energy from said power source and supply energy to said load; and
a control system that monitors power consumption by the load and history, as well as the characteristics of said energy storage system, and controls the use of the power source and energy storage system to maximize the efficiency of the fuel-driven power source when operational.

2. The system according to claim 1, wherein the energy storage system includes Li-ion batteries.

3. The system according to claim 2, wherein the Li-ion batteries may be depleted to at least 50% depth of discharge.

4. The system of claim 1 wherein the power source is a genset.

5. The system according to claim 4, further including a standby generator having an output capacity smaller than the capacity of the genset, yet suitable for recharging the energy storage system.

6. The system according to claim 1 wherein the control system is programmable and includes set-points which further control the operation of the power source and energy storage system.

7. The system according to claim 6, wherein said controller is capable of controlling the operation of the system in accordance with a plurality of modes.

8. The system of claim 7, wherein the operational mode of the system, as controlled by the control system, is selected from the group consisting of:
a true hybrid mode where the power source is operated in response to a state-of-charge of the energy storage system;
a forced silent mode where the power source is disabled;
a bypass mode where the energy storage system is disabled; and
a recovery mode where the energy storage system is recharged.

9. The system according to claim 1, wherein said energy storage system and said control system are affixed to a skid frame.

10. The system according to claim 9, wherein said skid frame may be affixed to a trailer.

11. A method for the reliable and efficient delivery of remote power to a load, including:
operating a fuel-driven power source to provide power to the load;
providing a rechargeable energy storage system, that is capable of receiving power from the power source and providing power to the load; and
using a control system, monitoring power consumption by the load and the history of such consumption, as well as the characteristics of the energy storage system, and controlling the use of the power source and energy storage system to operate the power source at its highest output efficiency.

12. The method according to claim 11, wherein the energy storage system includes Li-ion batteries.

13. The method according to claim 12, wherein the Li-ion batteries are depleted to at least 50% dept of discharge.

14. The method of claim 11 wherein the power source is provided by a genset.

15. The method according to claim 14, wherein the power source further includes providing a standby generator having an output capacity smaller than the capacity of the genset, yet suitable for recharging the energy storage system.

16. The method according to claim 11 further including programming set-points which control the operation of the power source and energy storage system.

17. The method according to claim 16, wherein said controller controls the operation of the system in accordance with one of a plurality of modes.

18. The method of claim 17, wherein the mode of the system is selected from the group consisting of:
a true hybrid mode where the power source is operated in response to a state-of-charge of the energy storage system;
a forced silent mode where the power source is disabled;
a bypass mode where the energy storage system is disabled; and
a recovery mode where the energy storage system is recharged.
